(19) United States
(12) Patent Application Publication
(10) Pub. No.: US 2024/0271515 A1
(43) Pub. Date: Aug. 15, 2024

(54) DIRECT FEED PROPPANT SYSTEM

(71) Applicant: NATIONAL OILWELL VARCO, L.P., Houston, TX (US)

(72) Inventors: Travis Lee Bolt, Conroe, TX (US); Eric O'Reilly Sears, College Station, TX (US); Jonathan Tyler Maxwell, Willis, TX (US); Tiffany Louise Matthews, Bryan, TX (US); Travis Adair Anderson, Seguin, TX (US); Sandor Weaver Grimes, Bryan, TX (US); Scott Allen Toler, College Station, TX (US); Mason SC Matlock, Mauldin, SC (US)

(21) Appl. No.: 18/569,137

(22) PCT Filed: Jun. 15, 2022
(86) PCT No.: PCT/US2022/072967

§ 371 Date: Dec. 11, 2023

Related U.S. Application Data
(60) Provisional application No. 63/202,574, filed on Jun. 16, 2021.

(51) Int. Cl. E21B 43/26; B01F 35/21; B01F 35/221; E21B 43/267

(52) U.S. Cl. CPC E21B 43/2607; B01F 35/2111; B01F 35/2114; B01F 35/22141; E21B 43/267; B01F 35/2132; B01F 35/2134

(57) ABSTRACT

A proppant supply system can include a fluid supply system including a blender configured to receive and mix liquid and proppant to form a proppant slurry. and an electrically driven conveyor configured and arranged for direct and metered delivery of proppant to the blender. The proppant supply system can include a proppant source configured to discharge proppant to the conveyor. and a control system for controlling a speed of the conveyor, to control a rate at which proppant is delivered to the blender.

### CLAIM OF PRIORITY

This patent application claims the benefit of priority to U.S. Provisional Application Ser. No. 63/202,574, filed Jun. 16, 2021, which is incorporated by reference herein in its entirety.

### TECHNICAL FIELD

The present disclosure relates to supplying proppant to hydraulic fracturing (frac, fracing, or fracking) operations at a well site, and more particularly, to systems, equipment, and methods for delivering proppant to a blender from an onsite storage container.

### BACKGROUND

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

During the hydraulic fracturing process of oil and gas wells, proppant, water, and additives are mixed together in a blender to create a homogenous proppant slurry. The proppant slurry is then delivered to a manifold system and pumped into a well at high pressure to fracture the formation, allowing the proppant slurry to flood the resulting fracture cracks and fissures. After the fracturing process, the water and additives are pumped out of the well, leaving the proppant in the cracks and fissures to act as a porous support structure. This allows the oil and/or gas from the formation to flow into the well bore for subsequent collection.

Recent technological advancements in hydraulic fracturing and in drilling capabilities have resulted in a dramatic increase in the amount of proppant required. For example, the fracturing process can be broken down into multiple individual “stages,” often including anywhere from 20 to 30 or more separate stages. Each stage can require anywhere from 300,000 to more than 500,000 pounds of proppant. As such, proppant supply logistics such as transporting proppant to a well site, on site-storage of proppant, efficient metering and delivery of proppant to a blender, and delivering a blended proppant slurry to a fracking well can be helpful in establishing a successful, modern fracking operation.

Existing systems and methods of supplying a proppant slurry to a fracking well include a variety of limitations such as delivering an inconsistent slurry concentration at a low-end or a high-end delivery rate, excessive generation of hazardous dust, and occupying an undesirably large footprint at fracking sites. These systems include independent metering systems to meter the amount of proppant transferred from an onsite storage container to a blender, to correspondingly control the concentration of the resulting blended proppant slurry. For example, existing proppant storage containers can include manually or electrically controlled discharge gates to control the amount of proppant falling onto the conveyor, or the conveyor can carry an uncontrolled amount of proppant to a separate hopper and auger system, where the auger rotates at a specified rate to meter the amount of proppant entering the blender.

In systems utilizing an auger, the rotation speed of the auger is used to determine an approximate delivery rate of proppant to the blender, often in terms of pounds per minute. The concentration of the resulting proppant slurry exiting the blender is calculated by combining the delivery rate with a fluid flow rate into the blender. The concentration can also be confirmed downstream of the blender, such as with a sensor measuring the density of the proppant slurry, which can be helpful in adjusting the delivery rate of proppant to the blender.

### BRIEF DESCRIPTION OF THE DRAWINGS

The drawings illustrate generally, by way of example, but not by way of limitation, various embodiments discussed herein.

FIG. 1 illustrates a perspective view of a proppant supply system, in accordance with one or more examples of the present application.

FIG. 2 illustrates a top plan view of a proppant supply system, in accordance with one or more examples of the present application.

FIG. 3A illustrates a cross-section of proppant containers positioned on a base, in accordance with one or more examples of the present application.

FIG. 3B illustrates a side view of proppant containers positioned on bases of the proppant supply system, in accordance with one or more examples of the present application.

FIG. 3C illustrates a close-up view of a discharge chute of a proppant container, in accordance one or more examples of the present application.

FIG. 4A illustrates a cross-section of proppant containers positioned on a base of the proppant supply system, in accordance with one or more examples of the present application.

FIG. 4B illustrates a side view of a base of a proppant supply system, in accordance with one or more examples of the present application.

FIG. 5 illustrates a perspective view of bases of the proppant supply system, in accordance with one or more examples of the present application.

FIG. 6 illustrates a perspective view of a base and a blender of the proppant supply system, in accordance with one or more examples of the present application.

FIG. 7 illustrates an example of a method of supplying proppant slurry to a frac fleet, in accordance with one or more examples of the present application.

### DETAILED DESCRIPTION

The following description and the drawings sufficiently illustrate specific examples to enable those skilled in the art to practice them. Other examples can incorporate structure, process, or other changes. Portions and features of some examples can by include in, or substituted for, those of other examples. Examples set forth in the claims encompass all available equivalents of those claims.

This disclosure, in one or more embodiments, can provide a proppant supply system capable of delivering a homogenous proppant slurry to a fracking well, at a consistent concentration, without the use of an independent metering system. The proppant supply system can, instead, utilize an electrically driven and enclosed conveyor operable to control a rate at which proppant is discharged into a blender as a function of the conveyor speed. The electrically driven conveyor can also increase the range of speeds at which the conveyor can consistently move proppant, at both low-end and high-end delivery rates, relative to traditional hydraulically driven conveyors. The proppant supply system can include a closed loop control system to automatically control the conveyor speed based on a user-specified proppant slurry concentration, and thus, automatically control the concentration of proppant slurry exiting the blender. The present disclosure can also improve the redundancy of proppant supply systems by including multiple conveyors, significantly decreasing the footprint size of a proppant supply system, and minimizing, or eliminating, the generation of hazardous dust with enclosures. Thus, the present disclosure addresses several issues long associated with current proppant supply systems for hydraulic fracturing.

The above overview is intended to provide an overview of subject matter of the present patent application. It is not intended to provide an exclusive or exhaustive explanation. The description below is included to provide further information about the present disclosure.

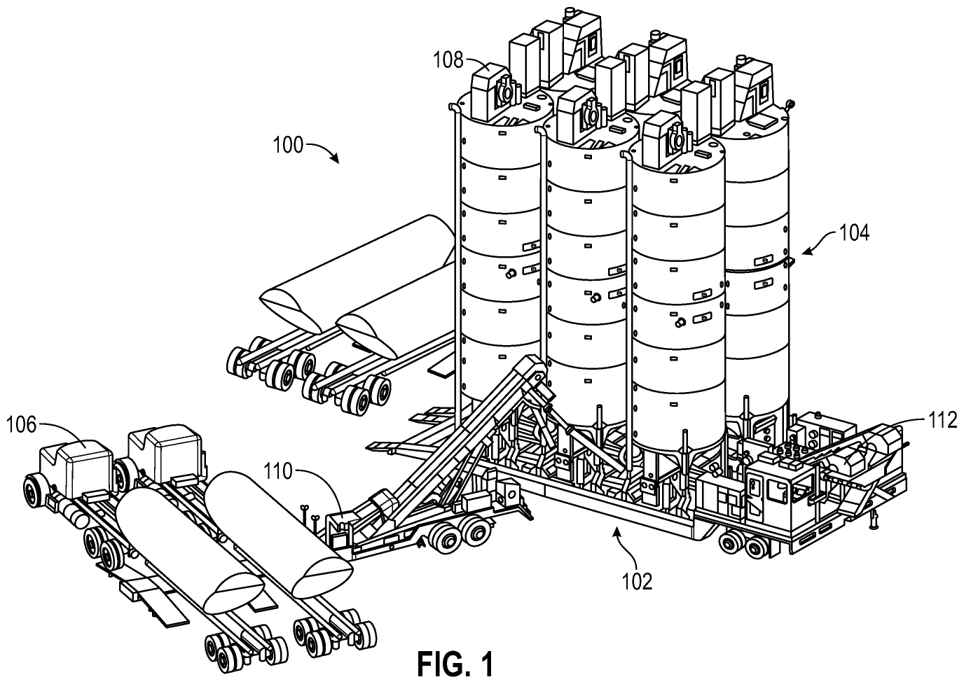

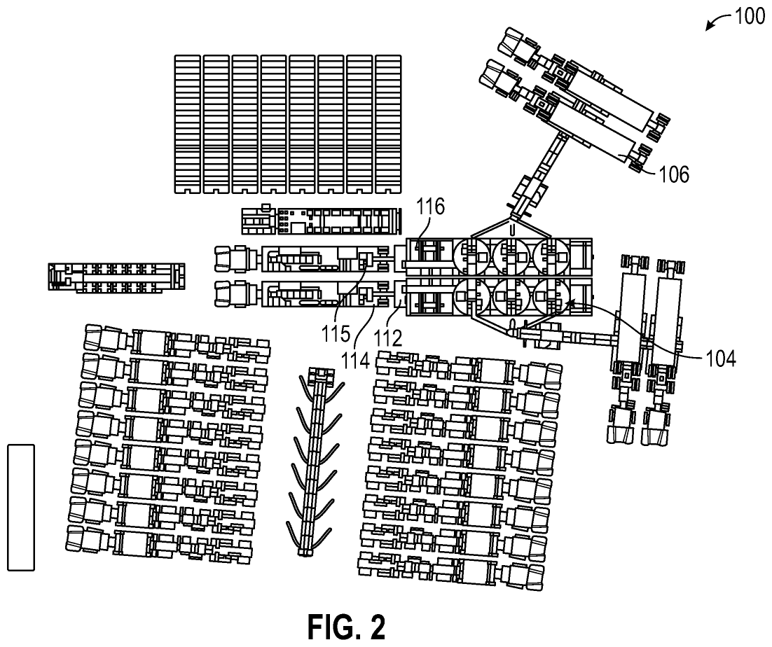

FIGS. 1-2 illustrate perspective and top plan views of a proppant supply system 100, respectively, in accordance with one or more examples of the present application. FIGS. 1-2 are discussed below concurrently. As illustrated in FIGS. 1-2, the proppant supply system 100 can include at least one base 102 and a proppant source.
The proppant source can be, for example, one or more proppant containers 104. The proppant containers 104 can be configured for placement on, and can be secured to, each base 102. Each base 102 can be adapted to erect a number of proppant containers 104 on or near a well pad, or otherwise on the ground at a fracking site. Each base 102 can also function as a trailer for transporting various components of the proppant supply system 100, including the one or more proppant containers 104. The primary focus of the present disclosure can be on the base 102 and its

relationship to the proppant containers 104. However, more broadly, the proppant supply system 100 can include a number of other components and operational aspects as discussed herein. The proppant containers 104 can generally be configured to receive proppant from one or more trucks 106 configured for transporting proppant to the fracking site. Each of the proppant containers 104 can include an integrated bucket elevator 108 for transferring proppant from the trucks 106 into the proppant containers 104, for on-site storage. The bucket elevators 108 can be arranged within the proppant containers 104, to protect the bucket elevators 108 while concurrently reducing the overall footprint size of the proppant supply system 100.

The proppant supply system 100 can also include a drive-over system 110. The drive-over system 110 can allow for high volumes of proppant to be delivered quickly to the bucket elevators 108, from the trucks 106. The drive-over system 110 can be adapted for delivering proppant at rate less than, the same as, or exceeding the rate at which the bucket elevators 108 are capable of lifting proppant into the proppant containers 104. The drive-over system 110 can be configurable to meet shipping restrictions. For example, the drive-over system 110 can be adapted to avoid specific transportation permitting in selected operational states within the United States. Each base 102 can include a conveyor 112. For example, the conveyor 112

can be a belt conveyor extending along a length of the base 102, under the proppant containers 104. The conveyor 112 can be enclosed within the base 102. The proppant containers 104 can also include enclosed discharge chutes. The enclosed discharge chutes can extend between the proppant containers 104 and an enclosure of the conveyor, which can together limit a maximum depth of proppant accumulation on the conveyor 112. As such, the rate of proppant exiting the proppant containers 104 onto the conveyor 112 can be directly proportional to the speed of the conveyor 112. Further, enclosing the proppant falling onto the conveyor 112, and the conveyor 112 itself, and can also reduce or eliminate the generation of hazardous dust and help to avoid contamination of the proppant with other materials.

The base 102 can be positioned adjacently to a blender 114. The conveyor 112 can convey the proppant discharged from the proppant containers 104 directly into a mixing tub 115 of the blender 114. The blender 114 can mix the proppant with water and other additives in the mixing tub 115, to create a proppant slurry. The transfer of proppant from the proppant containers 104 to the mixing tub 115 of the blender 114 can thereby be metered by the speed of the conveyor 112. Accordingly, the proppant supply system 100 can eliminate the need for an intermediate proppant metering system. The proppant supply system 100 can also include a control system 116. The control system 116 can be configured to control various components and operations of the proppant supply system 100, such as, but not limited to, functions of the bases 102, the proppant containers 104, and the blender 114. For example, a user can enter a specified proppant slurry concentration into a user interface of the control system 116. In response, the control system 116 can automatically regulate or otherwise control the speed of the conveyor 112, to meter the rate at which proppant is delivered to the blender 114. This and other aspects of the disclosure are further discussed in detail below.

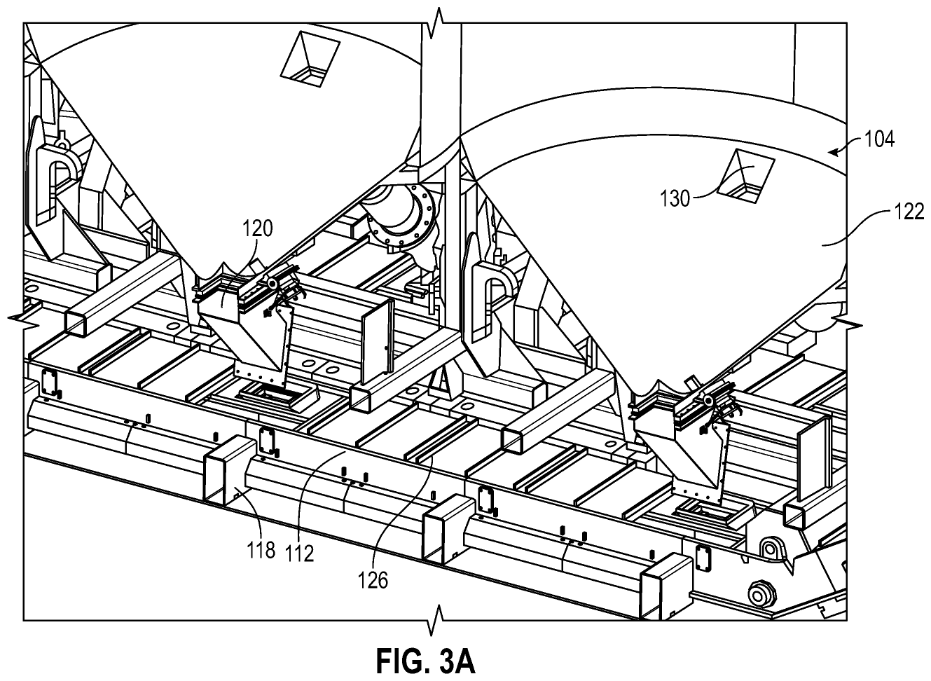

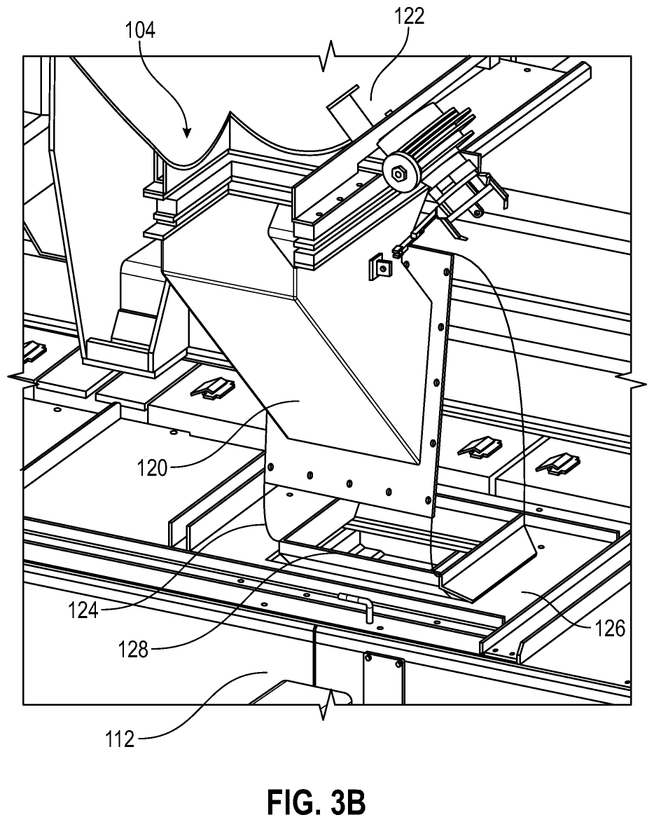

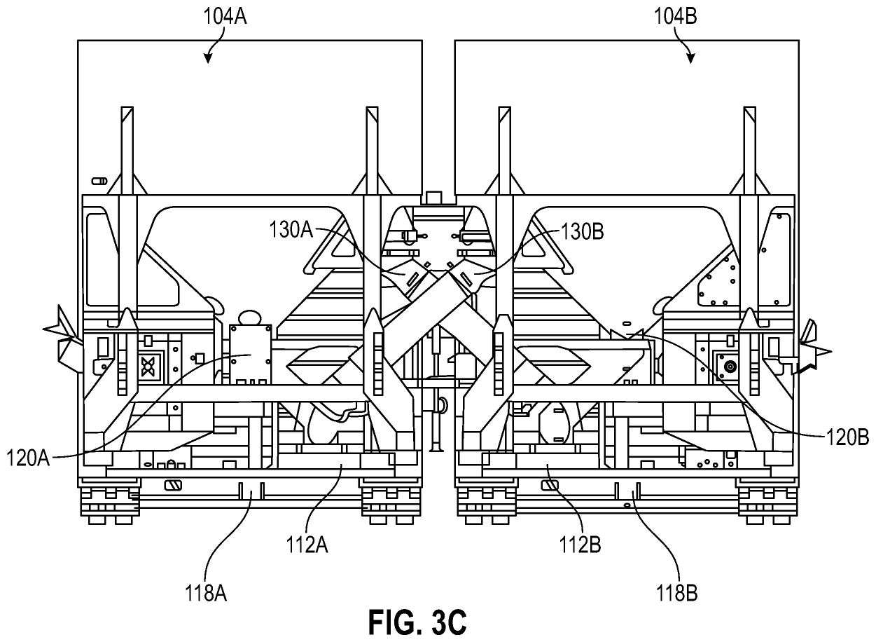

FIG. 3A illustrates a cross-section of proppant containers 104 positioned on a base 102, in accordance with one or more examples of the present application. FIG. 3B illustrates a side view of proppant containers 104 positioned on bases 102 of the proppant supply system 100, in accordance with one or more examples of the present application. FIG. 3C illustrates a close-up view of a discharge chute of a proppant container 104, in accordance with one or more examples of the present application. FIGS. 3A-3C are discussed below concurrently.

Each base 102 of the proppant supply system 100 can include a frame 118 configured for receiving and supporting one or more proppant containers 104. The proppant containers 104 can be arranged on the frame 118 in, for example, a three-pack or a six-pack configuration, as shown in FIGS. 1-2. In one or more examples, three proppant containers 104 can be positioned an individual conveyor 112. In other examples a variety of configurations can be used, such as a nine-pack or twelve-pack configuration. Additional combinations other than multiples of three can also be used, such as, 1, 2, 4, 5, 7, 8, 10, or 11 or integer values exceeding 12.

Each of the proppant containers 104 can be substantially identical in size and shape, but each can also be fractionally sized or otherwise vary in shape relative to other proppant containers 104. The proppant containers 104 can be generally cylindrical in shape. The proppant containers 104 can also comprise other three-dimensional shapes, such as rectangular or hexagonal prisms. The proppant containers 104 can greatly reduce the footprint of the proppant supply system 100 over existing systems due to the proppant containers being placed in close proximity to one another, and concurrently, arranged in an in-line fashion over the conveyor 112 in contrast to existing systems including proppant sources located adjacently to the conveyor 112.

Each proppant container 104 can include a discharge chute 120, to guide proppant onto the conveyor 112. The discharge chutes 120 can be arranged at or near a center of a conical portion 122 of each of the proppant containers 104. The conical portion 122 can generally be a bottom portion of each proppant container 104, adapted to funnel proppant into the discharge chute 120. The discharge chutes 120 can guide proppant out of the conical portion 122 and distribute the proppant evenly onto the conveyor 112 below. The discharge chutes 120 can help to enclose proppant falling onto the conveyor 112, to reduce or fully eliminate the generation of dust. Each of the discharge chutes 120 can extend downward from the conical portion 122 of each proppant container 104 and can be adapted to extend at various angles relative to the base 102.

Each of the discharge chutes 120 can also include a boot 124. The boot 124 is shown in shadow in FIG. 3B. The boot 124 can extend downward from each discharge chute 120. The boot 124 can be made from a variety of materials, for example, rubber, plastics, or metals. The boots 124 can also include or generally comprise, for example, a flexible hose or a section of tubing. The boots 124 can connect the discharge chute 120 to an enclosure 126. The enclosure 126 can completely or substantially extend around or encompass the conveyor 112 and can be secured to the frame 118 of the base 102. Each of the discharge chutes 120 can discharge proppant into the enclosure 126 onto the conveyor 112 through one or more openings 128. Each opening 128 can be configured to be located directly below the conical portion 122 of each proppant container 104, to allow each boot 124 to be coupled to each opening 128 in the enclosure 126.

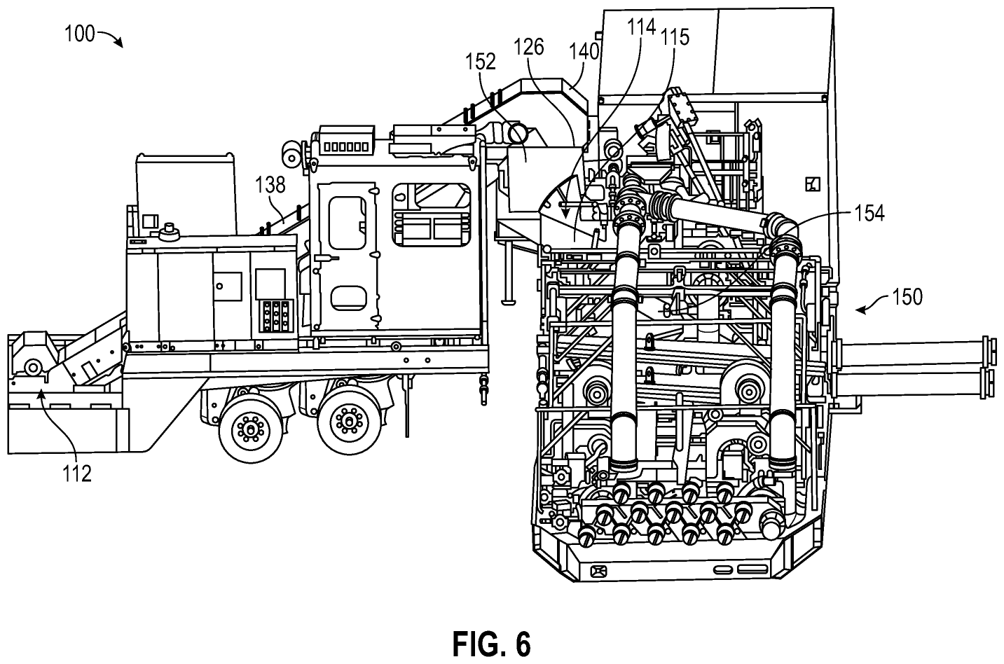

The enclosure 126, together with the proppant containers 104, can allow for choke-feeding of proppant to the conveyor 112, to allow the conveyor 112 to meter and define the delivery rate of proppant into, for example, the mixing tub 115 of the blender 114 shown in FIG. 2, and as further discussed below with regard to FIG. 6. A maximum rate at which the proppant containers 104 can feed proppant through the discharge chutes 120, the boots 124, and into the enclosure 126, can exceed a maximum rate at which the conveyor 112 can remove proppant from beneath the proppant containers 104. A vertical height of the enclosure 126, such as measured between a belt of the conveyor 112 and each opening 128, can define a maximum proppant depth at which proppant can accumulate on the conveyor 112. Once the enclosure 126 is filled to the maximum proppant depth, the flow of proppant from each of the boots 124 will be limited as excess proppant accumulates inside the boots 124 and the discharge chutes 120, and the flow of proppant will stop when proppant fills all of the available space within the enclosure 126, the boots 124, and the discharge chutes 120.

Accordingly, the rate at which additional proppant is discharged onto the conveyor 112, beyond the amount defined by the maximum proppant depth of the enclosure 126, can be directly proportional to, and can be defined by, a rate at which the conveyor 112 is conveying proppant away from the proppant containers 104. As such, each base 102, when combined with the proppant containers 104, can allow the conveyor 112 to concurrently meter and deliver proppant directly into a mixing tub of a blender, thereby eliminating the need for any independent proppant metering devices or systems positioned between a proppant storage container and a mixing tub of a blender.

Each of the proppant containers 104 can also include a secondary discharge chute 130. The secondary discharge chute 130 can be an opening defined in a surface of the conical portion 122 of each proppant container 104, above the discharge chute 120.
In some examples, such as shown in FIG. 3C, the proppant supply system 100 can include a first base 102A and a second base 102B, and as can be appreciated, a first 104A and a second 104B series of proppant containers positioned on the first 102A and second 102B bases. Likewise, and in contrast to known proppant supply systems, the present system may include two conveyors 112A and 112B mounted directly beneath the first 102A and second 102B series of proppant containers 104. In such an example, the secondary discharge chutes 130A and 130B can be adapted to discharge proppant to a neighboring and adjacent conveyor, such as conveyors 112B and 112A, respectively.

The conveyors 112A and 112B can each be shifted toward a generally inboard surface of their respective frames 118A and 118B, such that when the first base 102A and the second base 102B are arranged parallel to one another, the conveyors 112A and 112B are shifted toward one another relative to a centerline of each the of the first base 102A and the second base 102B. The use of at least the first 102A and second 102B base, and the secondary discharge chutes 130A and 130B, can help to can help to establish a redundant proppant supply system which can accommodate a conveyor failure by allowing any of the proppant containers 104 to access and alternatively discharge proppant onto a secondary and independent conveyor.

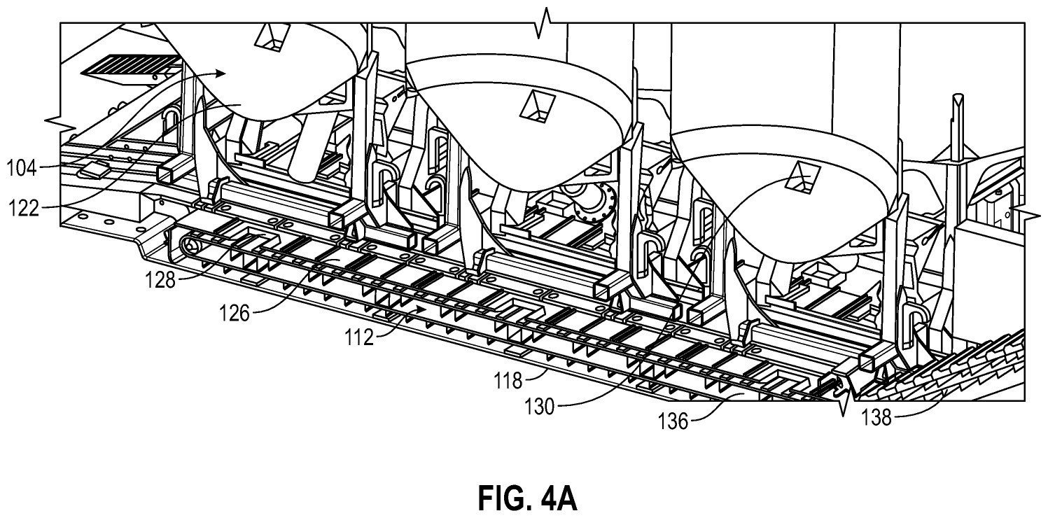

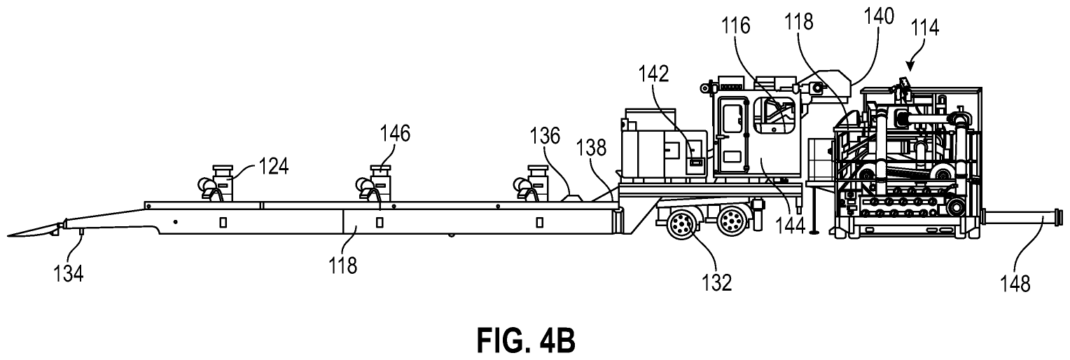

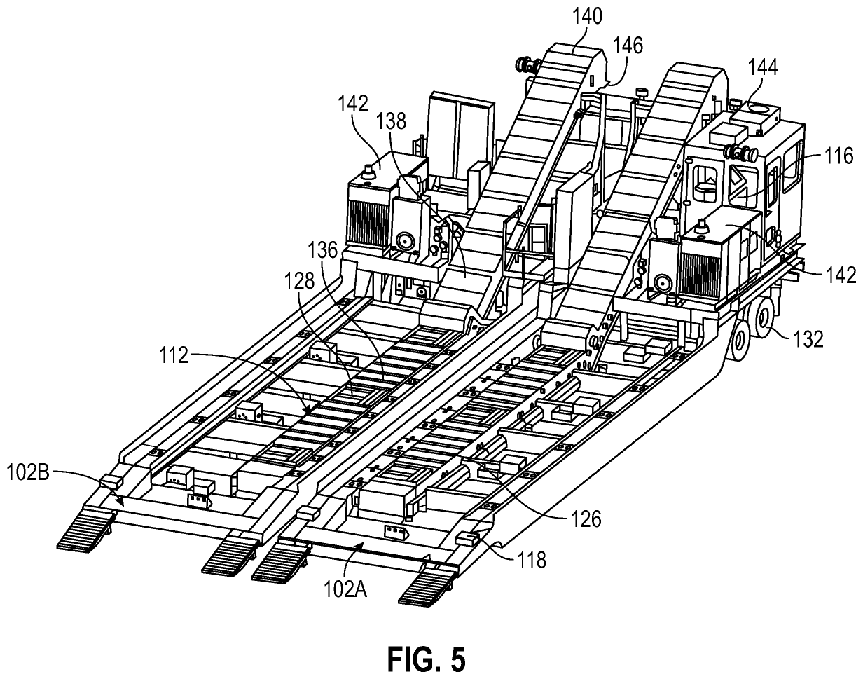

FIG. 4A illustrates a cross-section of proppant containers 104 positioned on a base 102 of the proppant supply system 100, in accordance with one or more examples of the present application. FIG. 4B illustrates a side view of a base 102 of a proppant supply system 100, in accordance with one or more examples of the present application. FIG. 5 illustrates a perspective view of bases 102 of the proppant supply system 100, in accordance one or more examples of the present application. FIGS. 4-5 are discussed below concurrently.

The bases 102 can generally be in the form of a trailerable mobile unit, including the frame 118 and a wheel and axle system 132, to rollably support a portion of the base 102 for convenient transportation within or between well sites. For example, as shown in FIG. 4B, the base 102 can be positioned directly adjacently to a blender 114. The wheel and axle system 132 can be, for example, but not limited to, a dual-axle system having 4 or 8 wheels. The wheel and axle system 132 can be arranged at an a generally opposite end from a tow hitch 134 for engaging a tractor or truck. The conveyor 112 can be partially, substantially, or fully recessed into the frame 118 of the base 102. The conveyor 112 can be configured to be within the footprint of, and extend directly, underneath one or more proppant containers 104 positioned on the frame 118. For example, the conveyor 112 can laterally convey proppant discharged from the proppant containers 104 along a length of the frame 118.

The conveyor 112 can further move proppant up an incline to the reach the blender 114. The conveyor 112 can include a first portion 136 and a second portion 138. The first portion 136 and the second portion 138 can be portions of a single belt conveyor. Alternatively, the first portion 136 and the second portion 138 can be individual and or otherwise separate belt conveyors. In such an example, the first portion 136 and second portion 138 can be coupled with a belt joint to prevent a loss of proppant from between the first portion 136 and the second portion 138. The first portion 136 can be a generally flat portion extending parallel to the frame 118 of the base 102. The second portion 138 of the conveyor 112 can be an upward sloping portion extending at an angle relative to the first portion 136. The enclosure 126 can extend and substantially encompass the first portion 136, the second portion 138, and in some examples, also the belt joint of the conveyor 112. A distal end 140 of the second portion 138, relative to the tow hitch 134, can generally be located at a height above the wheel and axle system 132. In some examples, the second portion 138 can also be adjustable with, for example, a hydraulic ram to configure the angle at which the second portion 138 extends relative to the first portion 136, to allow the distal end 140 of the second portion 138 to reach various heights above the blender 114, while concurrently allowing the base 102 to accommodate transportation requirements.

Each base 102 can generally be an electrically powered system (“e-system”).
As can be appreciated, the base 102 can include an electrical power source 142 for supplying power to various components of the proppant supply system 100. The power source 142 can be, for example, a gas turbine generator, grid power, or other types of electrical power sources. The power source 142 can be in direct electrical communication with the control system 116. The base 102 can include a cabin 144. The cabin 144 can have a maximum height at or less than the distal end 140 of the second portion 138 of the conveyor 112 to accommodate transportation restrictions.

The cabin 144 can include some components of the control system 116. The cabin 144 can contain a user interface of the control system 116. A user can thus utilize the user interface to control various operations and components of the proppant supply system 100 including, but not limited to, the bases 102, proppant containers 104, bucket elevators 108, conveyors 112, and the blender 114 from within the cabin 144. For example, a user can input a selected proppant slurry concentration into the user interface, and the control system 116 can automatically operate relevant components of the proppant supply system 100 to achieve and maintain a continuous supply of proppant slurry at the selected concentration to a frac fleet. In some examples, such as shown in FIG. 5, the proppant supply system 100 can include a first base 102A and a second base 102B. In such an example, the first base 102A can be the driving unit including the cabin 144 and the second base 102B can rely on the first base 102A for controls, information, and signals.

The control system 116 can include one or more sensors to monitor various operational parameters of the proppant supply system 100. For example, the control system 116 can include a discharge sensor 146. The discharge sensor 146 can be configured to measure a rate of proppant being discharged into the blender 114. The discharge sensor 146 can be, for example, but not limited to, an ultrasonic sensor. The discharge sensor 146 can be positioned, for example, within the enclosure 126 at a distal end 140 of the second portion 138 of the conveyor 112. The discharge sensor 146 can alternatively be positioned between the distal end 140 and the blender 114, or otherwise within the blender 114. The control system 116 can be in signal communication (wired or wireless) with the discharge sensor 146. The control system 116 can thereby monitor the amount of proppant falling from the distal end 140 of the conveyor 112 into the blender 114, and in response, the control system 112 can maintain or alter the speed of the conveyor 112 to achieve a specified slurry concentration.

The control system 116 can also include a concentration sensor 154. The concentration sensor 154 can be configured to monitor or confirm the concentration of the proppant slurry exiting the blender. The concentration sensor 152 can be positioned downstream of the blender 114, such as within a pipe carrying the proppant slurry away from the blender 114. The concentration sensor 154 can measure the density of the proppant slurry to determine the concentration of proppant relative to water and additives. The control system 116 can be in signal communication (wired or wireless) with the concentration sensor 154. The control system 116 can thereby monitor the concentration of proppant slurry exiting the blender, and in response, the control system 112 can maintain or alter the speed of the conveyor 112 to achieve a specified slurry concentration. The concentration sensor 154 can also thereby function as a redundant or separate means on monitoring the delivery of proppant from the conveyor 112 to the blender 114.

The control system 116 can be in signal communication with, for example, one or more variable frequency drives (VFDs) or eddy current drives, to control the speed of the conveyor 112. In contrast to existing hydraulic proppant conveyors, the electrically driven conveyor 112 can, provide finer and more precise control over the speed of the conveyor 112. For example, an electric motor can consistently drive and maintain the conveyor 112 when the conveyor is loaded with proppant and turning at a speed between 100-0 rpms, 50-25 rpms, or 25-0 rpms. Hydraulically drive systems often cannot consistently maintain a selected speed of a loaded conveyor below a speed of about 100 rpm. Additionally, an electric motor can also allow for a finer adjustment and greater modulation of the conveyor speed relative to a hydraulic drive system, at both low and high rates of speed.

FIG. 6 illustrates a perspective view of a base 102 and a blender 114 of the proppant supply system 100, in accordance with one or more examples of the present application. The blender 114 can include the mixing tub 115. The blender 114 can be configured to mix proppant with fluids or other additives to create a proppant slurry within the mixing tub 115. The base 102, including the conveyor 112, can be arranged directly adjacent to the mixing tub 115 of the blender 114. The second portion 138 of the conveyor 112 can be positioned such that a distal end 140 of the second portion 138 extends over and above the mixing tub 115 of the blender 114 to enable direct feeding of proppant into the blender 114. As discussed with reference to FIGS. 1-3 above, the amount of proppant falling onto a belt of the conveyor 112 is proportional to the speed of the conveyor 112. Thus, the proppant supply system 100 can effectively meter delivery of proppant to the blender 114 without an intermediate proppant metering system located between the conveyor 112 and the mixing tub 115.

In the absence of a proppant metering system located between the conveyor 112 and the mixing tub 115, and without more, the conveyor 112 may have a distal end 140 arranged well above the height of the mixing tub. That is, the conveyor 112 of the proppant supply system 100 may be sized and shaped similarly to pre-existing conveyors that are used with a traditional hopper and auger proppant metering system. These hopper/auger systems are typically located between the conveyor and the mixing tub to control the rate of proppant entering the blender. To provide space for the hopper and auger system, the distal end of the conveyor in these circumstances is commonly located well above the mixing tub; at a height sufficient to allow both the hopper and the auger to be supported below the distal end of the conveyor, but above the mixing tub. Mixing tubs used with such systems often define a relatively low maximum height, such as, but not limited to, 42-45 inches, 46-49 inches, or 50-52 inches.

Where the hopper and auger system is omitted as in the present proppant supply system 100, the mixing tub 115 can be sized to make up for the space normally taken up by the hopper and auger system and allowing the distal end 140 of the conveyor 112 to be positioned in close proximity to the mixing tub 115. For example, the mixing tub 115 can define a maximum height such as, but not limited to, 78-83 inches, 84-88 inches, or 89-93 inches. This can help to prevent the generation of dust, or imprecise metering due to a portion of the proppant falling from the conveyor 112 missing the mixing tub 115, such as caused by the conveyor 112 being positioned at an excessive height above the mixing tub 115. The mixing tub 115 can thereby help to enable direct delivery of proppant to the blender 114 by allowing the distal end 140 of the second portion 138 of the conveyer 112 to be positioned proximal to the mixing tub 115.

The mixing tub 115 can also include an extension 152 configured to meet or interface with a portion of the enclosure 126, at or near the distal end 140 of the second portion 138 of the conveyor 112. The extension 152, together with the enclosure 126, can substantially or completely encompass proppant falling from the conveyor 112 into the mixing tub 115 of the blender 114, to further reduce or eliminate the generation of dust and improve metering precision. As can be appreciated, the blender 114 can be a component of a fluid supply system 150. The fluid supply system 150 can include a water source and a chemical additive source operable to selectively supply water or chemical additives to the mixing tub 115. The fluid supply system 150 can include processing equipment for receiving water, chemicals, and proppant from their respective sources. The fluid supply system 150 can be in signal communication (wired or wireless) with the control system 116, in order to control the proportional mixing of proppant, water, and additives within the mixing tub 115 of the blender 114 to achieve a selected proppant slurry concentration for use in a hydraulic fracking operation. The fluid supply system 150 can also be in low pressure fluid communication with a manifold system and a pressurization system to supply the proppant slurry to a fracking well.

The manifold system can be in signal communication (wired or wireless) with the control system 116 to control, for example, delivery of low-pressure proppant slurry from the fluid supply system 150 to a pressurization system. The pressurization system can be configured to receive the low-pressure proppant slurry and increase the pressure to supply high pressure proppant slurry to a well head. For example, the pressurization system can include a number of pressurization units each including a motor, a controller such as a VFD, and a pump. The motor can drive the pump under the control of the VFD and can pressurize the low-pressure proppant slurry fluid from the fluid supply system 150. For the purposes of receiving the low-pressure proppant slurry and delivering the high-pressure proppant slurry, each of the pressurization units can be in both low-pressure fluid communication and in high-pressure fluid communication with the manifold system. The control system 116 can thus control delivery of the proppant slurry to a manifold system, pressurization of the proppant slurry, and delivery of high-pressure proppant slurry to a fracking fleet or a fracking well.

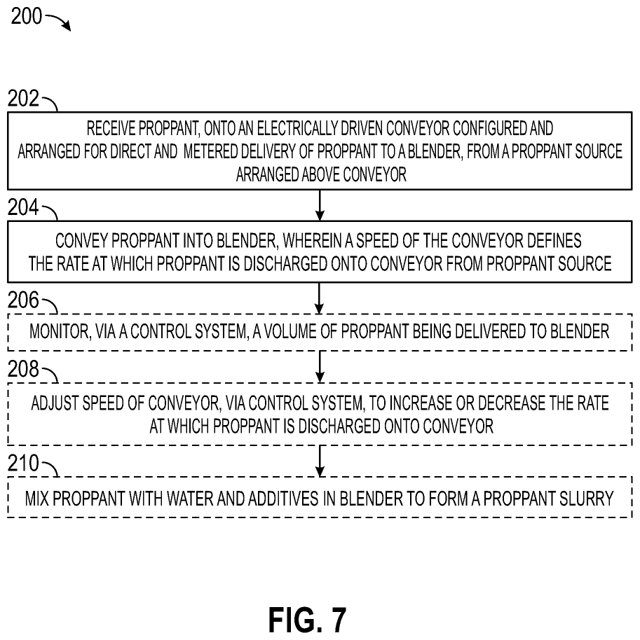

FIG. 7 illustrates an example of a method 200 of supplying a proppant slurry, in accordance with at least one example of the present application. The method 200 can begin with operation 202. Operation 202 can include receiving proppant, onto an electrically driven conveyor configured and arranged for direct and metered delivery of proppant to a blender, from a proppant source arranged above the conveyor. For example, proppant can be choke-fed to the conveyor via discharge chutes extending between a proppant container of the proppant source and an enclosure encompassing the conveyor. The enclosure can limit a maximum depth of proppant accumulation on the conveyor, allowing the speed of the conveyor to control the rate at which additional proppant exits the proppant source into the enclosure encompassing the conveyor. Additionally, or alternatively, proppant can be discharged out of a secondary discharge chute of the proppant source and onto a second conveyor arranged adjacently to the conveyor and to the proppant source. In some examples, the second conveyor can be arranged below a second proppant source arranged adjacently to the proppant source.

The method 200 can include operation 204. Operation 204 can be conveying proppant into the blender, wherein a speed of the conveyor defines the rate at which proppant is discharged onto the conveyor from the proppant source. For example, the conveyor can extend between the proppant source and a blender. When the conveyor is actively driven by an electric motor, such in response to a command from a control system, the conveyor will carry proppant deposited on the conveyor from the proppant source to a distal end of the conveyor, where it can fall into the blender located below the distal end of the conveyor. Additionally, the speed of the conveyor can directly control or otherwise define the rate of at which proppant is discharged onto the conveyor, as explained above with regard to operation 202.

The method 200 can include operation 206. Operation 206 can be monitoring, via a control system, a volume of proppant being delivered to the blender from the conveyor. For example, the control system can be in communication with a first and/or a second sensor. The first sensor can be located below a distal end of the conveyor and can be configured to measure a rate of proppant falling into the blender from the conveyor. The first sensor can be, for example, an ultrasonic sensor. The second sensor located within a passage guiding proppant slurry out of the blender and can be configured to measure a density of the proppant slurry. The second sensor can be, for example, a nuclear densiometer.

The method 200 can include operation 208. The operation 208 can be adjusting the speed of the conveyor, via the control system, to increase or decrease the rate at which proppant is discharged onto the conveyor. In some examples, adjusting the speed of the conveyor can include sending, via the control system, a signal to a variable frequency drive controlling an electric motor driving the conveyor. For example, the control system can control the speed of the conveyor with a VFD in signal communication with the control system and the electric motor driving the conveyor. In some examples, adjusting the speed of the conveyor can based on a signal from the first and or the second sensors as discussed above with regard to operation 206. For example, the first or the second sensors can send a signal to the control system indicating that an excessive, or inadequate, volume of proppant is being delivered to the blender.

The method 200 can include an operation 210, to mix the proppant with water and additives to form a proppant slurry. For example, the blender can be a component of a fluid supply system. The blender can mix proppant discharged from the conveyor with fluids such as water and chemical additives supplied to the blender, by other components of the fluid supply system, to form a proppant slurry. The control system can control the portions of proppant, water, and additives entering the blender to control the composition of the proppant slurry exiting the blender.

In operation and use, several methods may be performed with the proppant supply system 100 discussed above. The steps or operations of the method 200 are illustrated in a particular order for convenience and clarity, however some operations can be performed in parallel or in a different sequence without materially impacting other operations. The method 200 as discussed includes operations that can be performed by different actors, devices, and/or systems. It is understood that subsets of the operations discussed in the method 200 can be attributable to a single actor, device, or system, and could be considered a separate standalone process or method.

The proppant supply system of the present disclosure can provide a number of benefits over known proppant supply systems. The proppant containers can choke-feed proppant to an enclosed and electrically driven conveyor, allowing the conveyor itself to operate as a metering device. Given the electrically driven nature of the conveyor, the conveyor can have a greater operating speed range and the speed can also be more precisely controlled and modulated over existing hydraulically driven conveyors. The combination of a choke feed system and the precise control of the conveyor speed allow for the elimination of otherwise necessary metering devices or systems. Additionally, in contrast to other proppant supply systems, the present system can have a much smaller overall footprint due to the placement of proppant containers directly over the conveyor, emit less dust, and improve redundancy/backup with a secondary conveyor.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

### Notes And Examples

Example 1 is a proppant supply system, comprising: a fluid supply system including a blender configured to receive and mix liquid and proppant to form a proppant slurry; and an electrically driven conveyor configured and arranged for direct and metered delivery of proppant to the blender.

In Example 2, the subject matter of Example 1 includes, a proppant source configured to choke feed proppant to the conveyor, such that a speed of the conveyor defines a rate at which proppant is discharged from the proppant source to the conveyor.

In Example 3, the subject matter of Example 2 includes, wherein the proppant source is coupled to an enclosure substantially encompassing the conveyor, the enclosure configured to limit a maximum proppant depth on the conveyor.

In Example 4, the subject matter of Example 3 includes, wherein the proppant source includes a plurality of proppant containers, each of the plurality of proppant containers configured to discharge proppant onto the conveyor through a discharge chute extending into the enclosure.

In Example 5, the subject matter of Examples 1-4 includes, wherein the conveyor includes a first portion and a second portion, the second portion separate from and positioned at an angle relative to the first portion.

In Example 6, the subject matter of Examples 1-5 includes, wherein the conveyor is a first conveyor, and the system further comprises a second conveyor arranged adjacently and parallel to the first conveyor.

In Example 7, the subject matter of Example 6 includes, wherein the proppant source includes a first series of proppant containers arranged above the first conveyor and a second series of proppant containers arranged above the second conveyor, wherein each of the first and the second series of proppant containers includes secondary discharge chutes operable to deliver proppant to the second conveyor and to the first conveyor, respectively.

Example 8 is a proppant supply system, comprising: a fluid supply system including a blender configured to receive and mix liquid and proppant to form a proppant slurry; and an electrically driven conveyor configured and arranged for direct and metered delivery of proppant to the blender; a proppant source configured to discharge proppant to the conveyor; an electrically driven conveyor configured and arranged for direct and metered delivery of proppant to the blender; a control system for controlling a speed of the conveyor, to control a rate at which proppant is delivered to the blender.

In Example 9, the subject matter of Example 8 includes, wherein the conveyor is driven by an electric motor, the electrical motor under the control of a variable frequency drive in signal communication with the control system.

In Example 10, the subject matter of Examples 8-9 includes, a first sensor located below a distal end of the conveyor, first sensor in signal communication with the control system and configured to monitor the rate at which proppant is delivered to the blender.

In Example 11, the subject matter of Example 10 includes, wherein the first sensor is an ultrasonic sensor.

In Example 12, the subject matter of Examples 8-11 includes, a second sensor located within a passage guiding proppant slurry out of the blender, the second sensor in signal communication with the control system and configured to monitor a concentration of the proppant slurry.

In Example 13, the subject matter of Example 12 includes, wherein the second sensor is nuclear densiometer.

Example 14 is a method of supplying a proppant slurry, the method comprising: receiving proppant, onto an electrically driven conveyor configured and arranged for direct and metered delivery of proppant to a blender, from a proppant source arranged above the conveyor; conveying proppant into the blender, wherein a speed of the conveyor defines the rate at which proppant is discharged onto the conveyor from the proppant source.

In Example 15, the subject matter of Examples 13-14 includes, monitoring, via a control system, a volume of proppant being delivered to the blender from the conveyor.

In Example 16, the subject matter of Example 15 includes, wherein monitoring the volume of proppant being delivered to the blender is accomplished with a first sensor located below a distal end of the conveyor, the first sensor configured to measure a rate of proppant falling into the blender from the conveyor.

In Example 17, the subject matter of Examples 15-16 includes, wherein monitoring the volume of proppant being delivered to the blender is accomplished with a second sensor located within a passage guiding proppant slurry out of the blender, the first sensor configured to measure a density of the proppant slurry.

In Example 18, the subject matter of Examples 15-17 includes, adjusting the speed of the conveyor, via the control system, to increase or decrease the rate at which proppant is discharged onto the conveyor.

In Example 19, the subject matter of Example 18 includes, wherein adjusting the speed of the conveyor includes sending, via the control system, a signal to a variable frequency drive controlling an electric motor driving the conveyor.

In Example 20, the subject matter of Examples 13-19 includes, mixing the proppant with water and one or more additives, in the blender, to form a proppant slurry.

Example 22 is an apparatus comprising means to implement of any of Examples 1-20.

Example 23 is a system to implement of any of Examples 1-20.

Example 24 is a method to implement of any of Examples 1-20.

What is claimed is:

1. A proppant supply system, comprising:
a fluid supply system including a blender configured to receive and mix liquid and proppant to form a proppant slurry; and
an electrically driven conveyor configured and arranged for direct and metered delivery of proppant to the blender.

2. The system of claim 1, further comprising a proppant source configured to choke feed proppant to the conveyor, such that a speed of the conveyor defines a rate at which proppant is discharged from the proppant source to the conveyor.

3. The system of claim 2, wherein the proppant source is coupled to an enclosure substantially encompassing the conveyor, the enclosure configured to limit a maximum proppant depth on the conveyor.

4. The system of claim 3, wherein the proppant source includes a plurality of proppant containers, each of the plurality of proppant containers configured to discharge proppant onto the conveyor through a discharge chute extending into the enclosure.

5. The system of claim 1, wherein the conveyor includes a first portion and a second portion, the second portion separate from and positioned at an angle relative to the first portion.

6. The system of claim 1, wherein the conveyor is a first conveyor, and the system further comprises a second conveyor arranged adjacently and parallel to the first conveyor.

7. The system of claim 6, wherein the proppant source includes a first series of proppant containers arranged above the first conveyor and a second series of proppant containers arranged above the second conveyor, wherein each of the first and the second series of proppant containers includes secondary discharge chutes operable to deliver proppant to the second conveyor and to the first conveyor, respectively.

8. A proppant supply system, comprising:
a fluid supply system including a blender configured to receive and mix liquid and proppant to form a proppant slurry;
an electrically driven conveyor configured and arranged for direct and metered delivery of proppant to the blender;
a proppant source configured to discharge proppant to the conveyor; and
a control system for controlling a speed of the conveyor, to control a rate at which proppant is delivered to the blender.

9. The system of claim 8, wherein the conveyor is driven by an electric motor, the electrical motor under the control of a variable frequency drive in signal communication with the control system.

10. The system of claim 8, further comprising a first sensor located below a distal end of the conveyor, first sensor in signal communication with the control system and configured to monitor the rate at which proppant is delivered to the blender.

11. The system of claim 10, wherein the first sensor is an ultrasonic sensor.

12. The system of claim 8, further comprising a second sensor located within a passage guiding proppant slurry out of the blender, the second sensor in signal communication with the control system and configured to monitor a concentration of the proppant slurry.

13. The system of claim 12, wherein the second sensor is nuclear densiometer.

14. A method of supplying a proppant slurry, the method comprising:
receiving proppant, onto an electrically driven conveyor configured for direct and metered delivery of proppant to a blender, from a proppant source arranged above the conveyor;
conveying proppant into the blender, wherein a speed of the conveyor defines the rate at which proppant is discharged onto the conveyor from the proppant source.

15. The method of claim 14, further comprising monitoring, via a control system, a volume of proppant being delivered to the blender from the conveyor.

16. The method of claim 15, wherein monitoring the volume of proppant being delivered to the blender is accomplished with a first sensor located below a distal end of the conveyor, the first sensor configured to measure a rate of proppant falling into the blender from the conveyor.

17. The method of claim 15, wherein monitoring the volume of proppant being delivered to the blender is accomplished with a second sensor located within a passage guiding proppant slurry out of the blender, the first sensor configured to measure a density of the proppant slurry.

18. The method of claim 15, further comprising adjusting the speed of the conveyor, via the control system, to increase or decrease the rate at which proppant is discharged onto the conveyor.

19. The method of claim 18, wherein adjusting the speed of the conveyor includes sending, via the control system, a signal to a variable frequency drive controlling an electric motor driving the conveyor.

20. The method of claim 14, further comprising mixing the proppant with water and one or more additives, in the blender, to form a proppant slurry.
